(19) United States
(12) Patent Application Publication
(10) Pub. No.: US 2026/0269408 A1
(43) Pub. Date: Sep. 10, 2026

(54) TRAY APPARATUS FOR SECONDARY BATTERY

(71) Applicant: SK On Co., Ltd., Seoul (KR)

(72) Inventors: Jae Hyeok YU, Daejeon (KR); Eun Sol KO, Daejeon (KR)

(21) Appl. No.: 19/557,115

(22) Filed: Mar. 5, 2026

(30) Foreign Application Priority Data
Mar. 6, 2025 (KR) 10-2025-0029090

(51) Int. Cl. H01M 50/267; H01M 10/42; H01M 10/44; H01M 10/615; H01M 10/653; H01M 10/657; H01M 50/204; H01M 50/289

(52) U.S. Cl. CPC H01M 50/267; H01M 10/425; H01M 10/441; H01M 10/445; H01M 10/446; H01M 10/615; H01M 10/653; H01M 10/657; H01M 50/204; H01M 50/289; H01M 2010/4278

(57) ABSTRACT

Proposed is a tray apparatus for a secondary battery, and the tray apparatus includes a body unit provided for mounting a plurality of secondary batteries in a heating-vacuum-charging equipment, a plurality of heating units arranged at side surfaces and/or lower portions of the plurality of secondary batteries mounted to the body unit, and heating the plurality of secondary batteries, and a moving unit movable on the body unit, and the tray apparatus is capable of heating secondary batteries with simple structure and configuration during a heating-vacuum-charging process, and flexibly corresponding to the secondary batteries of different specifications.

### CROSS REFERENCE TO RELATED APPLICATION

The present application claims priority to Korean Patent Application No. 10-2025-0029090, filed Mar. 6, 2025, the entire contents of which are incorporated herein for all purposes by this reference.

### BACKGROUND OF THE INVENTION

### Field of the Invention

The present disclosure relates to a tray apparatus for a secondary battery.

### Description of the Related Art

Demand for secondary batteries that deliver high power and energy density has been increasing rapidly across various industries, including electric vehicles (EVs), energy storage systems (ESS), and portable electronic devices. A heating-vacuum-charging (HVC) process, which is a step in secondary battery manufacturing, may significantly affect performance, stability, and lifespan of the secondary batteries.

The HVC process heats secondary batteries to a predetermined temperature and charges the secondary batteries under vacuum to simultaneously achieve stabilization of internal electrolyte and improvement in charge efficiency. The HVC process may be performed in a predetermined sequence after a plurality of secondary batteries is stored in a tray unit inserted into a heating-vacuum-charging (HVC) equipment.

In general, the HVC process may be performed by loading a plurality of secondary batteries on a tray in an aligned state, and then automatically inserting the tray into the HVC equipment. The tray may be designed to secure the locations of the secondary batteries and enable the precise HVC process.

The HVC equipment may improve charge efficiency by removing residual gas from the interior of the secondary battery while vacuuming the interior, and performing a charging process. The charged secondary batteries may be discharged outside the equipment after undergoing a stabilization process. The discharged secondary batteries may undergo a quality test and then be transferred to the next process.

The above-described HVC equipment is primarily optimized for secondary batteries of a single specification, which may limit its ability to flexibly correspond to secondary batteries with different sizes and shapes (hereinafter, which are referred to as “specifications”).

Furthermore, the configuration for heating secondary batteries to a target temperature in the HVC equipment may be complex in the equipment and raise equipment costs.

Therefore, demand for solutions that can flexibly correspond to the secondary batteries of various specifications and enable simple heating at low cost is gradually increasing.

### SUMMARY OF THE INVENTION

According to an aspect of the present disclosure, an objective of the present disclosure is to provide a tray apparatus for a secondary battery, the tray apparatus being capable of heating secondary battery during a heating-vacuum-charging process.

Another objective of the present disclosure is to provide a tray apparatus for a secondary battery, the tray apparatus being capable of flexibly corresponding to secondary batteries of different specifications, and easily heating the secondary battery.

According to another aspect of the present disclosures, an objective of the present disclosure is to provide a tray apparatus for a secondary battery, which is applied in green technology fields such as electric vehicles and battery charging stations, and is widely used in other battery-powered technologies, such as solar and wind power generation.

According to the embodiment of the present disclosure, there is provided a tray apparatus for a secondary battery, the tray apparatus including: a body unit provided for mounting a plurality of secondary batteries in a heating-vacuum-charging equipment; a plurality of heating units arranged at side surfaces and/or lower portions of the plurality of secondary batteries mounted to the body unit, and heating the plurality of secondary batteries; and a moving unit movable on the body unit.

Herein, the body unit may include a first power connection part to supply power to the heating units, and the heating-vacuum-charging equipment may include a second power connection part that may be automatically connected to the first power connection part and supply power to the first power connection part.

Furthermore, the body unit may include a limit block to limit a movable range of each of the heating units arranged at a side surface of each of the secondary batteries.

Furthermore, the limit block may be independently provided at each end of each of the heating units, and may include a sliding groove with a greater width than that of each end of each of the heating units.

Furthermore, a plurality of limit blocks may be provided in different specifications to correspond to the secondary batteries of different specifications.

Furthermore, the heating units may include: side heaters arranged at the side surfaces of the secondary batteries; and lower heaters arranged at the lower portions of the secondary batteries.

Furthermore, the side heaters may be installed in the limit blocks, and be configured to be moved within a preset range in the same direction as the moving direction of the moving unit when moved toward the secondary batteries by the moving unit.

Furthermore, the side heaters may be configured to come into close contact with the side surfaces of the secondary batteries when the side heaters receive external force from the moving unit.

Furthermore, the plurality of lower heaters of different heights may be provided to correspond to the secondary batteries of different heights.

Furthermore, the heating units may serve as heat conductors heated by a power source.

Furthermore, the moving unit may be provided to press a side surface of each secondary battery at one or more locations at the body unit.

Furthermore, the tray apparatus may include: a pressure detection unit arranged between the secondary batteries and configured to measure the pressure of the secondary batteries.

Furthermore, the tray apparatus may include: a control unit monitoring a real-time input value input by the pressure detection unit, automatically stopping operation of the heating-vacuum-charging equipment when an abnormal status occurs, and activating a warning device.

The features and advantages of the present disclosure will be more apparent from the following detailed description based on the accompanying drawings.

Further, it should be noted that the terms and words used in the specification and the claims should not be construed as being limited to ordinary meanings or dictionary definitions, and should be interpreted as having a meaning and a concept that are consistent with the technical idea of the present disclosure based on the principle that an inventor may appropriately define the concept of a term to best describe the present disclosure of the inventor.

According to the embodiment of the present disclosure, the secondary battery can be heated with simple configuration and structure during the HVC process.

Furthermore, the secondary battery can be easily heated while flexibly corresponding to secondary batteries of different specifications.

### BRIEF DESCRIPTION OF THE DRAWINGS

FIG. 1 is a plan view schematically showing a tray apparatus for a secondary battery according to the embodiment of the present disclosure.

FIG. 2 is a reference view schematically showing a power supply structure when the tray apparatus for a secondary battery according to the embodiment of the present disclosure is inserted into a heating-vacuum-charging equipment.

FIG. 3 is a partially enlarged view showing part A in FIG. 1, the view showing a status before pressing a moving unit.

FIG. 4 is a reference view schematically showing the connection relation among heating units, limit blocks, secondary batteries, and the moving unit in the tray apparatus for a secondary battery according to the embodiment of the present disclosure.

FIG. 5 is a reference view showing the limit blocks provided in different specifications to correspond to changes in the width of secondary batteries.

FIG. 6 is a reference view showing the limit blocks provided in different specifications to correspond to changes in the side area of secondary batteries.

FIG. 7 is a reference view showing lower heaters formed in different heights to correspond to changes in the thickness of the secondary batteries.

FIG. 8 is a view showing an operational state after the moving unit shown in FIG. 3 is pressed.

FIG. 9 is a block diagram showing the control relation of the tray apparatus for a secondary battery under the pressure of the secondary battery according to the embodiment of the present disclosure.

### DETAILED DESCRIPTION OF THE DISCLOSURE

The terminology used to describe embodiments of the present disclosure is not intended to limit the present disclosure. It should be noted that expressions in singular may include expressions in plural unless the context clearly indicates otherwise.

In assigning reference numerals to components of the drawings, it should be noted that the same components are given the same reference numerals as much as possible even when they are shown in different drawings, and similar reference numerals are given to similar components.

The drawings may be schematic or exaggerated to illustrate embodiments. In the present document, expressions such as “has”, “may have”, “comprises”, “may comprise”, “includes”, or “may include” indicate the presence of corresponding characteristics (e.g., a numerical value, function, operation, or component such as a part), and does not exclude the presence of additional characteristics.

Terms such as “one”, “other”, “another”, “first”, “second”, etc. are used to distinguish one component from another, and components are not limited by the above terms.

Herein, an exemplary embodiment of the present disclosure will be described in detail with reference to accompanying drawings.

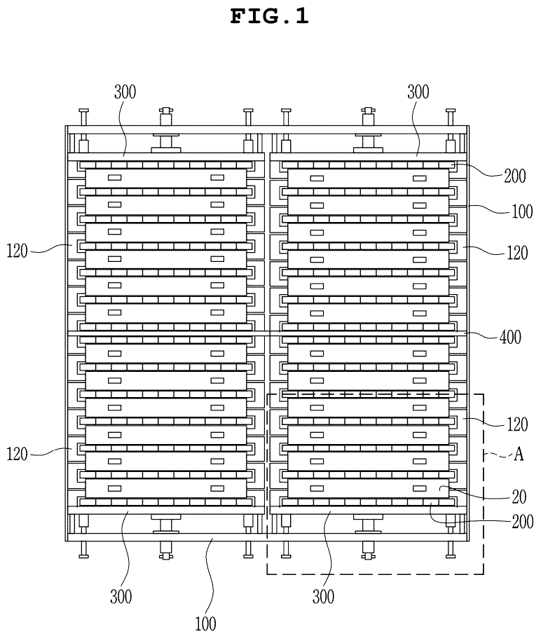

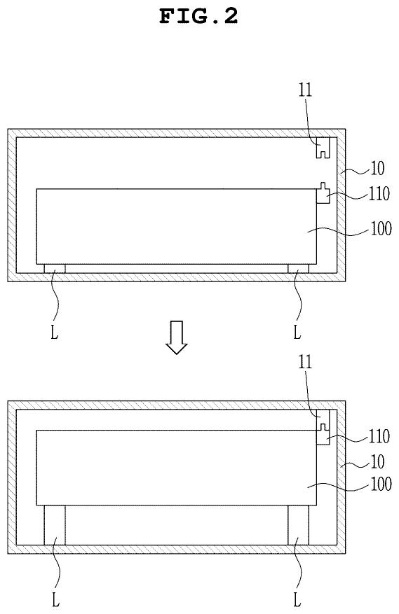

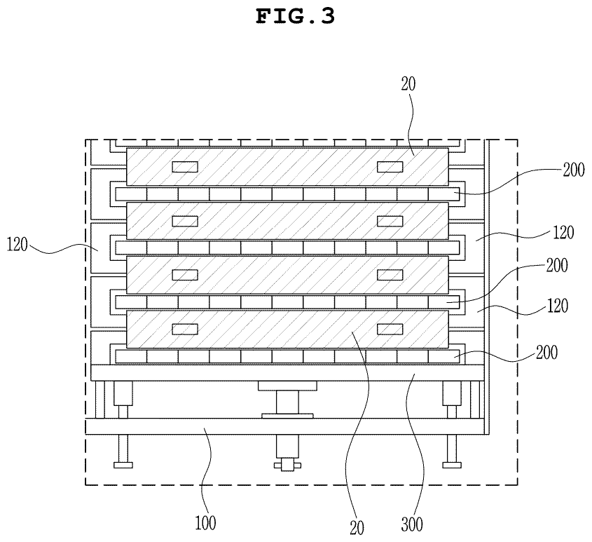

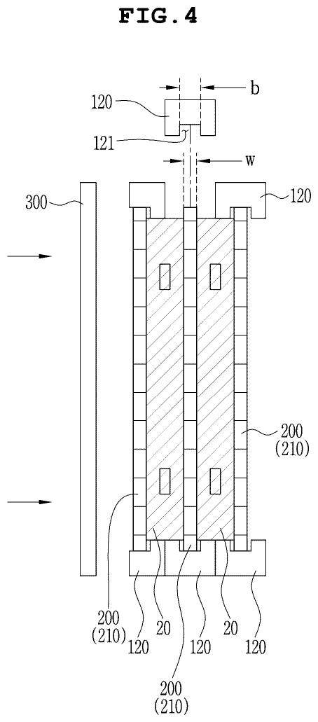

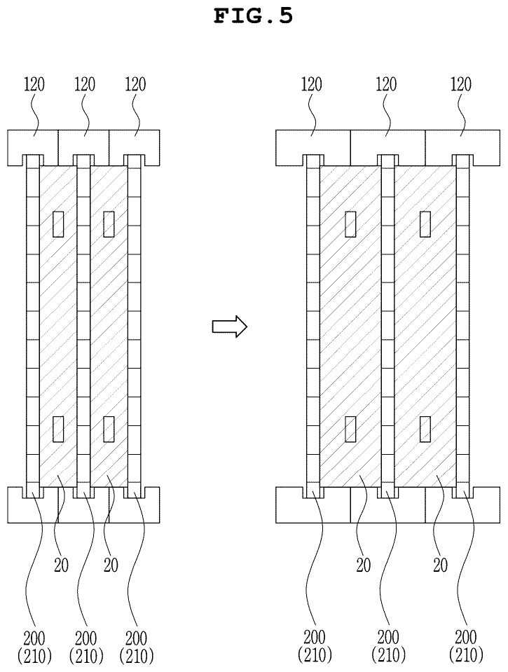

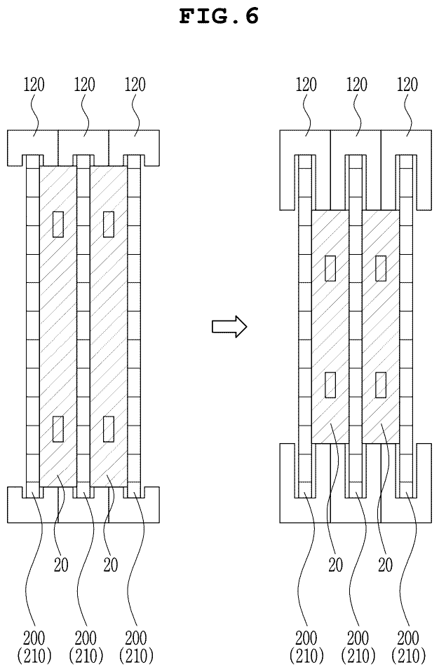

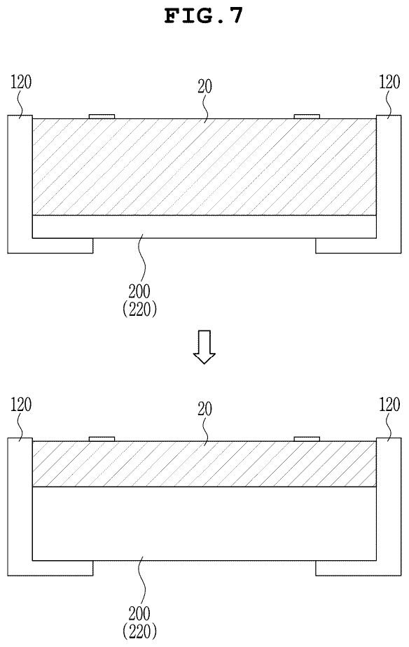

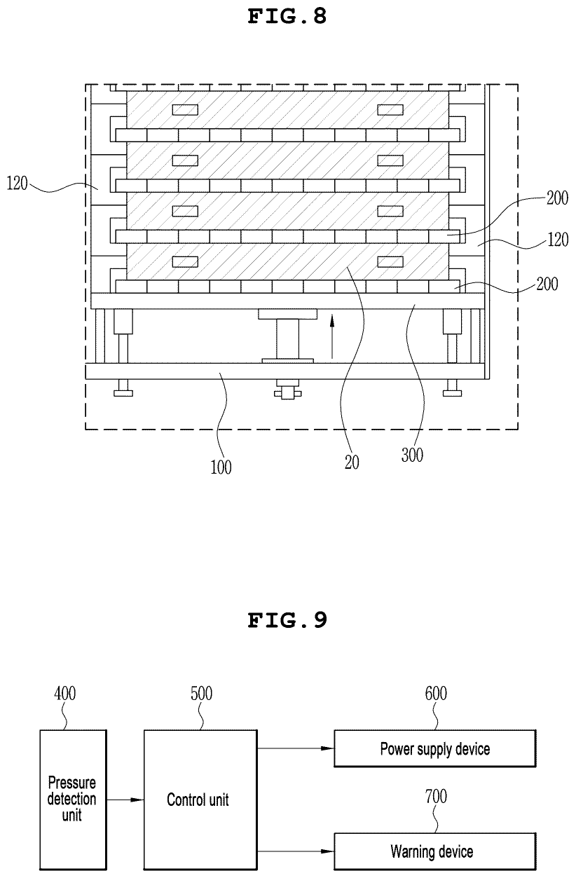

FIG. 1 is a plan view schematically showing a tray apparatus for a secondary battery according to the embodiment of the present disclosure. FIG. 2 is a reference view schematically showing a power supply structure when the tray apparatus for a secondary battery according to the embodiment of the present disclosure is inserted into a heating-vacuum-charging equipment. FIG. 3 is a partially enlarged view showing part A in FIG. 1, the view showing a status before pressing a moving unit. FIG. 4 is a reference view schematically showing the connection relation among heating units, limit blocks, secondary batteries, and the moving unit in the tray apparatus for a secondary battery according to the embodiment of the present disclosure. FIG. 5 is a reference view showing the limit blocks provided in different specifications to correspond to changes in the width of secondary batteries. FIG. 6 is a reference view showing the limit blocks provided in different specifications to correspond to changes in the side area of secondary batteries. FIG. 7 is a reference view showing lower heaters formed in different heights to correspond to changes in the thickness of the secondary batteries. FIG. 8 is a view showing an operational state after the moving unit shown in FIG. 3 is pressed. FIG. 9 is a block diagram showing the control relation of the tray apparatus for a secondary battery under the pressure of the secondary battery according to the embodiment of the present disclosure.

According to the embodiment of the present disclosure, the tray apparatus for a secondary battery may include: a body unit 100 provided for mounting a plurality of secondary batteries 20 in a heating-vacuum-charging equipment 10; a plurality of heating units 200 arranged at side surfaces and/or lower portions of the secondary batteries 20 mounted in the body unit 100 and heating the secondary batteries 20; and a moving unit 300 provided to be movable on the body unit 100.

As shown in FIG. 1, the body unit 100 provides the entire exterior shape of the tray apparatus for a secondary battery according to the embodiment of the present disclosure and is configured to mount the plurality of secondary batteries 20 in the heating-vacuum-charging equipment 10 into which the tray apparatus for a secondary battery enters.

The body unit 100 is formed in a structural shape that can stably mount the secondary batteries 20, and during the heating-vacuum-charging process using the heating-vacuum-charging equipment 10, the body unit 100 may secure and support the secondary batteries 20 to prevent deformation or damage to the secondary batteries.

The body unit 100 provides a storage space to accommodate the plurality of secondary batteries 20, and may be configured such that the secondary batteries 20 are aligned in a single row or in two or more rows. Furthermore, the heating units 200 may be installed at the body unit 100 to heat the secondary batteries 20.

Herein, the body unit 100 includes a first power connection part 110 to supply power to the heating units 200, and the heating-vacuum-charging equipment 10 may include a second power connection part 11 that is automatically connected to the first power connection part 110 and supplies power.

As shown in FIG. 2, the first power connection part 110 may be provided at a portion of the body unit 100 to supply power to the heating units 200. Furthermore, the second power connection part 11 may be formed at a portion of the heating-vacuum-charging equipment 10 into which the tray apparatus for a secondary battery is inserted, and may be electrically connected to the first power connection part 110 to supply power.

As shown in FIG. 2, when the tray apparatus for a secondary battery is inserted into the heating-vacuum-charging equipment 10, the body unit 100 may be lifted by the lifting device L. Accordingly, the first power connection part 110 of the body unit 100 is automatically connected to the second power connection part 11 of the heating-vacuum-charging equipment 10, so that the first power connection part 110 may receive power from the second power connection part 11 and supply power to the heating units 200. Herein, the lifting device L lifting the body unit 100 may be composed of a hydraulic cylinder or a servomotor.

Meanwhile, as shown in FIG. 3, the heating units 200 may be arranged at side surfaces or lower portions of the secondary batteries 20 mounted in the body unit 100.

The heating units 200 are elements that heat the secondary batteries 20, increasing their temperature. The heating units 200 may be arranged on the side surfaces of the secondary batteries 20, at the lower portions of the secondary batteries 20, or on both the side surfaces and the lower portions of the secondary batteries 20.

Herein, the body unit 100 may include limit blocks 120 to limit the movable range of the heating units 200 arranged at the side surfaces of the secondary batteries 20.

The limit blocks 120 may limit the movable range of the heating units 200 (specifically, side heaters 210 of the heating units 200, which will be described below) in the body unit 100.

The limit blocks 120 prevent the heating units 200 (specifically, the side heaters 210) from exerting excessive pressure on the secondary batteries 20 or reaching incorrect positions, thereby inducing stable heat transfer and protection for the secondary batteries 20 when the secondary batteries 20 are heated.

Specifically, each limit block 120 is independently provided at either end of each heating unit 200, and may include a sliding groove having the width b greater than the width w of either end of the heating units 200.

As shown in FIG. 4, each limit block 120 may be independently arranged at either end of the heating units 200 (specifically, the side heaters 210). Accordingly, the limit blocks 120 may control the movement of the heating units 200 at opposite ends of the heating units 200, thereby allowing the heating units 200 to be moved uniformly and precisely.

Each of the limit blocks 120 may include the sliding groove 121 with the width b greater than the width w of each heating unit 200, thereby limiting the movable range of each heating unit 200. Therefore, each heating unit 200 may be moved toward or away from each secondary battery 20 within the sliding groove 121 of each limit block 120.

The movable range of the heating units 200 in the limit blocks 120 is limited by the sliding groove 121, and the limited movable range may prevent excessive pressure exerting the secondary batteries 20 and deformation of the heating units 200, when the heating units 200 are moved toward the secondary batteries 20 by the moving unit 300.

Herein, the plurality of limit blocks 120 may be provided in different specifications to correspond to the secondary batteries 20 of different specifications.

The secondary batteries 20 may be manufactured in various specifications with different widths, side areas, heights, etc., and the plurality of limit blocks 120 may also be provided in different specifications to correspond to the secondary batteries 20 of different specifications.

In other words, as shown in FIG. 5, when the width of the secondary batteries 20 is changed (increased), the limit blocks 120 may be provided in a specification that can correspond to the secondary batteries 20 with a changed width. Accordingly, the plurality of limit blocks 120 may be provided in different specifications to correspond to each specification of the secondary batteries 20. For example, since the specification of the secondary batteries 20 is preset, the specification of each limit block 120 may also be preset to correspond to the specification of the secondary batteries 20.

Furthermore, as shown in FIG. 6, when the side area of the secondary batteries 20 is changed (decreased), the limit blocks 120 may also be provided in a specification that can correspond to the specification of the secondary batteries 20 with a changed side area. Herein, the specification of each heating unit 200 may be maintained without changing into the specification according to the specification of the secondary batteries 20. The limit blocks 120 changed in specification in response to the specification of the secondary batteries 20 may secure the secondary batteries 20 arranged between the heating units 200 not to be moved.

Meanwhile, the moving unit 300 may be provided at the body unit 100 so that the heating units 200 arranged at the side surfaces of the secondary batteries 20 and the secondary batteries 20 come into contact with each other. Therefore, as shown in FIGS. 3 and 4, the moving unit 300 may be moved in a direction in which the heating units 200 is into close contact with the secondary batteries 20 in the body unit 100.

As described above, when the moving unit 300 is moved, movement of the limit blocks 120 allows the heating units 200 installed at the limit blocks 120 to be moved toward the secondary batteries 20, so that the heating units 200 may come into close contact with the side surfaces of the secondary batteries 20. Accordingly, the secondary batteries 20 may be heated by the heating units 200.

Herein, since each heating unit 200 is moved only within the sliding groove 121 of each limit block 120 as described above, this limited moving range may prevent excessive pressure exertion on the side surface of each secondary battery 20 and deformation of the heating units 200. Furthermore, when the moving unit 300 does not press against the heating units 200, a non-contact state occurs, with a gap maintained between the heating units 200 and the secondary batteries 20, so that the secondary batteries 20 may be easily inserted into and removed from the body unit 100.

Specifically, the heating units 200 may include the side heaters 210 arranged on the side surfaces of the secondary batteries 20 and lower heaters 220 arranged at the lower portions of the secondary batteries 20.

In other words, the heating units 200 provided to heat the secondary batteries 20 may include the side heaters 210 and the lower heaters 220.

As shown in FIG. 6, the side heaters 210 may be configured to heat the secondary batteries 20 by contacting the side surfaces of the secondary batteries 20. Therefore, the side heaters 210 may be arranged at the side surfaces of the secondary batteries 20, and be installed at the limit blocks 120 and come into close contact with the side surfaces of the secondary batteries 20 by receiving external force from the moving unit 300.

Herein, the side heaters 210 may be installed at the limit blocks 120. When the side heaters 210 are moved toward the secondary batteries 20 by the moving unit 300, they may be moved within a preset range in the same direction as the moving unit 300.

The side heaters 210 may be moved with the limited movable range within the sliding grooves 121 of the limit blocks 120, and be moved in the same direction as the moving unit 300 to come into close contact with the side surfaces of the secondary batteries 20 to heat the secondary batteries 20.

In other words, when the side heaters 210 receive external force from the moving unit 300, the side heater 210 may come into close contact with the side surfaces of the secondary batteries 20.

Meanwhile, as shown in FIG. 7, the lower heaters 220 may be arranged at the lower portions of the secondary batteries 20 and may heat the secondary batteries 20 by closely contacting the lower portions of the secondary batteries 20.

The lower heaters 220 may be accommodated in the bottom portions of the limit blocks 120 to allow the secondary batteries 20 to be stacked thereon, and the lower heaters 220 may come into close contact with the lower portions of the secondary batteries 20 and heat the secondary batteries 20.

Herein, one of the side heaters 210 and the lower heaters 220 of the heating units 200 may be provided in the body unit 100, and if necessary, both the side heaters 210 and the lower heaters 220 may be provided to heat both the side surfaces and the lower portions of the secondary batteries 20, and implementers can make the appropriate choice according to their needs.

Furthermore, referring to FIG. 7, the plurality of lower heaters 220 of different heights may be provided to correspond to the secondary batteries 20 of different heights.

As described above, since the specifications of the secondary batteries 20 may vary, for example, when the heights (thickness) of the secondary batteries 20 are changed, to correspond to the change, the plurality of lower heaters 220 of different heights may be provided. Therefore, as shown in FIG. 7, the lower heaters 220, which have the height corresponding to that of the secondary batteries 20, are selected and arranged at the lower portions of the secondary batteries 20, thus maintaining the height of the secondary batteries 20 constant.

Furthermore, when the body unit 100 is inserted into the heating-vacuum-charging equipment 10 to allow the first power connection part 110 and the second power connection part 11 to be automatically connected to each other, the heating units 200, including the side heaters 210 and the lower heaters 220, may receive power from the first power connection part 110 and be heated.

In other words, the heating units 200 may be heat conductors heated by power.

The heat conductors provided as the heating units 200 may use heating-wire methods, and when installed in the heating units 200, the heat conductors are heated by a power supply and transmit heat. Heat conductors are not limited to heating wires, and various forms, such as surface-heating methods, may be used.

The moving unit 300 may be provided at one or more locations at the body unit 100 to press the side surfaces of the secondary batteries 20.

As shown in FIG. 8, the moving unit 300 may be mounted to the body unit 100 to press the side surfaces of the secondary batteries 20. The moving unit 300 may be moved from the body unit 100 toward the side surfaces of the secondary batteries 20. Accordingly, the moving unit 300 may slide toward the secondary batteries 20 or away from them.

The moving unit 300 may be arranged at a location on the body unit 100 and press the plurality of secondary batteries 20 mounted in the body unit 100, or a plurality of moving units 300 may be arranged at a plurality of locations on the body unit 100 and press the plurality of secondary batteries 20.

When the plurality of moving units 300 is provided at a plurality of locations, the moving units 300 are arranged at opposite locations facing each other as shown in FIG. 1, so that the heating units 200 come into close contact with the opposite side surfaces of the secondary batteries 20.

Meanwhile, as shown in FIG. 9, according to the embodiment of the present disclosure, the tray apparatus for a secondary battery may include a pressure detection unit 400 arranged between the secondary batteries 20 and configured to measure the pressure of the secondary batteries 20.

Furthermore, according to the embodiment of the present disclosure, the tray apparatus for a secondary battery may include a control unit 500 that monitors the real-time input value of the pressure detection unit 400, automatically stops the heating-vacuum-charging equipment 10, and activates a warning device 700 when an abnormal status occurs.

Referring to FIG. 1, the pressure detection unit 400 may be arranged between the side surfaces of the secondary batteries 20 and measure the pressure exerted from the secondary batteries 20 outward. The pressure detection unit 400 may use a load-cell method and measure the pressure between the secondary batteries 20. To precisely measure the pressure of the secondary batteries 20, as shown in FIG. 1, the pressure detection unit 400 may advantageously be arranged at a middle position among the secondary batteries 20 mounted in the body unit 100.

The pressure detection unit 400 may be formed in a size corresponding to the side area of one secondary battery 20, and when a plurality of rows of the secondary batteries 20 are aligned on the body unit 100, the pressure detection unit 400 may be provided in a size corresponding to the side area of the plurality of secondary batteries 20.

In other words, one pressure detection unit 400 may be configured to measure the pressure of the plurality of secondary batteries 20. For reference, when problems occur in the secondary batteries 20 mounted in the body unit 100, the secondary batteries 20 expand and increase in volume, and the pressure detection unit 400 may measure the pressure exerted by the secondary batteries 20 as their volume increases.

Furthermore, the control unit 500 may monitor real-time input values of the pressure detection unit 400, and when the input value of the pressure detection unit 400 is equal to or higher than a reference value preset to the control unit 500, the control unit 500 may determine that excessive expansion of the secondary batteries 20 occurs.

Therefore, to prevent thermal runaway of the secondary batteries 20 and fires in the heating-vacuum-charging equipment 10 when an abnormal condition occurs in the secondary batteries 20, the control unit 500 may control the heating-vacuum-charging equipment 10 to automatically stop operation.

At this point, the control unit 500 blocks a power supply device 600, which supplies electric power to the heating-vacuum-charging equipment 10, to automatically stop the equipment and prevent fires, and operates the separate warning device 700 to quickly notify users of emergency situations.

Hereinabove, the present disclosure has been described in detail through specific embodiments. The embodiments are provided to specifically describe the present disclosure, but the present disclosure is not limited thereto. Within the technical spirit of the present disclosure, it will be apparent that various modifications or changes are possible by those skilled in the art, and all modifications, equivalents, or alternatives of the present disclosure fall within the scope of the present disclosure.

What is claimed is:

1. A tray apparatus for a secondary battery, the tray apparatus comprising:
a body unit provided for mounting a plurality of secondary batteries in a heating-vacuum-charging equipment;
a plurality of heating units arranged at side surfaces and/or lower portions of the plurality of secondary batteries mounted to the body unit, and heating the plurality of secondary batteries; and
a moving unit movable on the body unit.

2. The tray apparatus of claim 1, wherein the body unit comprises a first power connection part to supply power to the heating units, and the heating-vacuum-charging equipment comprises a second power connection part that is automatically connected to the first power connection part and supplies power to the first power connection part.

3. The tray apparatus of claim 1, wherein the body unit comprises a limit block to limit a movable range of each of the heating units arranged at a side surface of each of the secondary batteries.

4. The tray apparatus of claim 3, wherein the limit block is independently provided at each end of each of the heating units, and comprises a sliding groove with a greater width than that of each end of each of the heating units.

5. The tray apparatus of claim 4, wherein a plurality of limit blocks is provided in different specifications to correspond to the secondary batteries of different specifications.

6. The tray apparatus of claim 2, wherein the heating units comprise:
side heaters arranged at the side surfaces of the secondary batteries; and
lower heaters arranged at the lower portions of the secondary batteries.

7. The tray apparatus of claim 6, wherein the side heaters are installed in the limit blocks, and are configured to be moved within a preset range in the same direction as the moving direction of the moving unit when moved toward the secondary batteries by the moving unit.

8. The tray apparatus of claim 7, wherein the side heaters are configured to come into close contact with the side surfaces of the secondary batteries when the side heaters receive external force from the moving unit.

9. The tray apparatus of claim 6, wherein the plurality of lower heaters of different heights is provided to correspond to the secondary batteries of different heights.

10. The tray apparatus of claim 1, wherein the heating units serve as heat conductors heated by a power source.

11. The tray apparatus of claim 1, wherein the moving unit is provided to press a side surface of each secondary battery at one or more locations at the body unit.

12. The tray apparatus of claim 11, further comprising:
a pressure detection unit arranged between the secondary batteries and configured to measure the pressure of the secondary batteries.

13. The tray apparatus of claim 12, further comprising:
a control unit monitoring a real-time input value input by the pressure detection unit, automatically stopping operation of the heating-vacuum-charging equipment when an abnormal status occurs, and activating a warning device.
